(19) United States
(12) Patent Application Publication
(10) Pub. No.: US 2026/0149305 A1
(43) Pub. Date: May 28, 2026

(54) SYSTEM AND PROCESS FOR ENERGY MINING

(71) Applicant: TM Electronic Technology, LLC, Dallas, TX (US)

(72) Inventor: Choon Sae Lee, Dallas, TX (US)

(73) Assignee: TM Electronic Technology, LLC, Dallas, TX (US)

(21) Appl. No.: 19/397,189

(22) Filed: Nov. 21, 2025

Related U.S. Application Data
(60) Provisional application No. 63/724,081, filed on Nov. 22, 2024.
(60) Provisional application No. 63/728,894, filed on Dec. 6, 2024.
(60) Provisional application No. 63/757,704, filed on Feb. 12, 2025.
(60) Provisional application No. 63/791,786, filed on Apr. 21, 2025.

(51) Int. Cl. H02J 50/00; H02J 50/05

(52) U.S. Cl. CPC H02J 50/001; H02J 50/05

(57) ABSTRACT

A system for collecting energy, comprising a stationary component disposed in an electric field and coupled to a capacitor, a dynamic component disposed adjacent to the stationary component in the electric field, the dynamic component including a load resistor and a device for creating a time-varying physical interaction between the stationary component and the dynamic component to generate a current flow in the load resistor.

### RELATED APPLICATIONS

The present application claims priority to and benefit of U.S. Provisional patent application 63/724,081 filed Nov. 22, 2024, U.S. Provisional patent application 63/728,894 filed Dec. 6, 2024, U.S. Provisional patent application 63/757,704 filed Feb. 12, 2025, and U.S. Provisional patent application 63/791,786 filed Apr. 21, 2025, each of which are incorporated by reference for all purposes as if set forth herein in their entireties.

### TECHNICAL FIELD

The present disclosure relates generally to harvesting environmental energy, and more particularly to systems and processes that harvest energy from an environment that includes a low-frequency electromagnetic field or static electric field.

### BACKGROUND OF THE INVENTION

Extracting energy from the environment has usually focused on high-frequency alternating electromagnetic (RF) fields.

### SUMMARY OF THE INVENTION

A system for collecting energy, comprising stationary components such as resistors and capacitors disposed in an electric field and coupled to dynamic components disposed adjacent to the stationary components in the electric field. The dynamic components include mechanical movements and/or switches. A device for creating a time-varying physical interaction is coupled between the stationary components and the dynamic components to generate a current flow in the load resistors.

For energy collection from low-frequency electromagnetic waves, unique resonant antennas are used where the antenna size is much smaller than the wavelength.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may not be to scale, but emphasis is placed upon clearly illustrating the principles of the present disclosure. Moreover, in the drawings, like reference numerals designate corresponding parts throughout the several views, and in which:

FIG. 1 is diagram of a system for harvesting DC energy from the environment, in accordance with an example embodiment of the present disclosure;

FIG. 2 is diagram of a system for a mechanical version for harvesting DC energy from the environment, in accordance with an example embodiment of the present disclosure;

FIG. 3 is diagram of a system for an electronic version of FIG. 2 for DC energy collection, in accordance with an example embodiment of the present disclosure;

FIG. 4 is diagram of a system for a mechanical version for DC energy collection with capacitors, in accordance with an example embodiment of the present disclosure;

FIG. 5 is diagram of a system for an electronic version of FIG. 4 for DC energy collection with capacitors, in accordance with an example embodiment of the present disclosure;

FIG. 6 is diagram of a system for a mechanical version for DC energy collection, in accordance with an example embodiment of the present disclosure;

FIG. 7 is diagram of a system for an electronic version of FIG. 6 for DC energy collection, in accordance with an example embodiment of the present disclosure;

FIG. 8 is system for AC energy collection, in accordance with an example embodiment of the present disclosure;

FIG. 9 is diagram of a system for use with the embodiment of the systems disclosed herein; and

FIG. 10 is diagram of a system for collecting AC energy, in accordance with an example embodiment of the present disclosure.

### DETAILED DESCRIPTION OF THE INVENTION

In the description that follows, like parts are marked throughout the specification and drawings with the same reference numerals. The drawing figures may not be to scale and certain components can be shown in generalized or schematic form and identified by commercial designations in the interest of clarity and conciseness.

The present application claims priority to and benefit of U.S. Provisional patent application 63/724,081 filed Nov. 22, 2024, U.S. Provisional patent application 63/728,894 filed Dec. 6, 2024, U.S. Provisional patent application 63/757,704 filed Feb. 12, 2025 and U.S. Provisional patent application 63/791,986 filed Apr. 21, 2025, each of which are incorporated by reference for all purposes as if set forth herein in their entireties. U.S. Pat. No. 9,698,619, issued Jul. 4, 2017, is incorporated by reference for all purposes as if set forth herein in its entirety.

Extracting energy from renewable energy sources such as solar, wind, and hydroelectric power is limited due to environmental conditions, such as weather and time of the day. The present disclosure provides systems and methods for collecting energy from electrical energy fields in the ambient environment. For example, static electric energy in the Earth's atmosphere is generated by cosmic radiation in the upper atmosphere. This static energy is relatively constant and uniformly distributed over the Earth's surface. The systems and methods of the present disclosure include collection devices that collect this static energy as well as other energy from the environment.

In another example embodiment, low frequency energy from sources such as Schumann resonance can be collected in accordance with the teachings of the present disclosure.

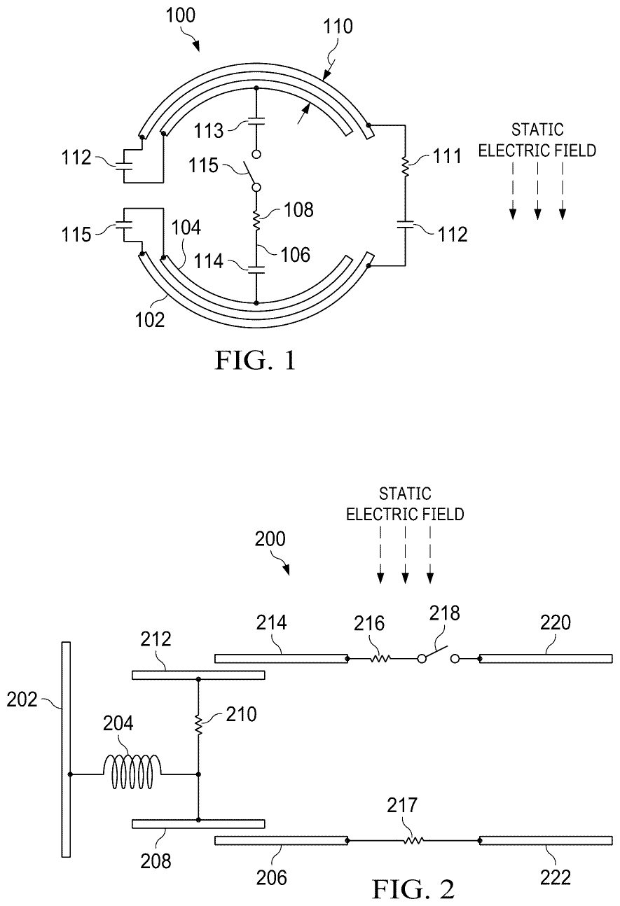

FIG. 1 is diagram of a system 100 for harvesting energy from the environment, in accordance with an example embodiment of the present disclosure, which becomes a power generator when the external electric field does not exist. System 100 includes inner rotating cylindrically shaped conducting plates 104, which are disposed within outer stationary cylindrically shaped conducting plates 102. Conducting connecting member 106 contains resistor 108 that electrically couples inner rotating cylindrically shaped conducting plates 104, and capacitance 112 and resistor 111 in series couple stationary cylindrically shaped conducting plates 102.

A gap 110 between the rotating cylindrically shaped conducting plates 104 and stationary cylindrically shaped conducting plates 102 produces an electromotive force (EMF) due to the mechanical movement of the inner conducting plates in presence of a static electric field in a closed-loop circuit. Without capacitance 112, the effective capacitance of the surrounding geometry is very small, resulting in a negligible current through resistors 108 and 111. However, with a high value of capacitance 112 and a reasonable rate of revolution of rotating cylindrically shaped conducting plates 104, the impedance of the capacitor can be small, resulting in a larger current through resistors 108 and 111. Other suitable combinations of capacitors and resistors can also or alternatively be used.

However, a high capacitance value of 112 reduces the electric field in the gap. To mitigate the reduction of the electric field in the gap, capacitor 112 is initially charged before the energy collection operation with a battery and a switch. Also to increase the charges on the rotating inner plates, two pairs of capacitors 112 and 113, and 114 and 115 are placed on outer and inner conductors such that those on the outer plates are fixed while those on the inner plates are rotating with the inner plates. They are electrically connected only when the inner and outer plates are aligned, by using conducting brushes, or other kinds for the same purpose. The two capacitors on the inner plates are connected with switch 115 and resistor 108 in series. The switch is on when the inner and outer plates are aligned, and then off such that the inner plates are polarized while the inner plates are away from the fixed outer plates. Assuming the external static outer field is in the same direction with the field between the outer shell, the inner shells accelerate more than without the external static field, resulting in extra energy collection. When the external static field strength is zero, the device becomes a power generator, converting from mechanical energy of the inner plates to electrical energy through the load resistors. When the external field is turned on, extra energy is collected from the external field.

As an example, suppose the diameters of the outer and inner cylindrical conducting shells are 100 cm and 98 cm, respectively, the lengths of the inner and outer conductors are 100 cm, the capacitance of the capacitor connecting outer plates is 1 mF, the capacitances of all other capacitors are 4 mF, the resistances of load resistors 108 and 111 are 100 Ohms, and the external electric field strength is 150 V/m. The time constant is in the range of 0.1 sec, and the efficient rotation speed is about 5 cycles per second. Assume the initial charges of all capacitors are about 1 C, and the plates are aligned, while the switch is on. When inner conductors are about to leave the overlapping space with the outer conductors, switch 115 is off so that the charges are transferred from the inner capacitors to the inner plates. The amount of charge depends on the capacitance of switch 115, which is negligible. The polarized charges on the upper and lower inner plates are approximately 1 C and −1 C, respectively, right after the overlapping regions. The additional force felt by each of the inner plates is 150 N, and the extra work to be done by the external electric field is 150 J, which happens at each half revolution. Thus, the power collected due to the external electrical field is 3 kW.

It is noted that no current flows externally and current is limited within the device. The collected power is AC.

FIG. 2 is diagram of a system 200 for harvesting energy from the environment, in accordance with an example embodiment of the present disclosure. System 200 includes conducting plates 208 and 212 that are electrically coupled through load resistor 210 and which are mechanically coupled to base 202 through spring 204. Plates 208 and 212 oscillate between plates A 206 and 214. Plates 206 and 214 and plate 220 and 222 are electrically connected through switch 218 and load resistors 216 and 217. The conducting plates 220 and 222 have a high potential difference and large charge reserve due to the static electric field. Initially, switch 218 is off. As conducting plates 212 and 208 are about to slide in between plates 206 and 214, the conducting plates 212 and 208 become polarized opposite to the plurality of plates 206 and 214, with concentrated charges near the edges of plates 206 and 214 and plates 208 and 212, which creates an attractive force between plates 206 and 214 and plates 208 and 212, according to Coulomb's Law. Plates 208 and 212 slide through between plates 206 and 214.

Moreover, when plates 208 and 212 are between plates 206 and 214, the energy of the system of plates 206 and 214 and plates 208 and 212 is lower when plates 208 and 212 are inside plates 206 and 214 than outside. Thus, plates 208 and 212 will continue to slide in until the inward force of plates 208 and 212 is substantially diminished and starts to be pulled by spring 204 attached to plates 208 and 212. At this point of time, switch 218 is turned on and charges flow to plate 214 from plate 220, and from plate 206 to plate 222. As plates 208 and 212 are being pulled out of plates 206 and 214, the charges return back to plate 214 from plate 220, and to plate 206 from plate 222. When plates 208 and 212 are about to be out of plates 206 and 214, switch 218 is turned off and the system returns to the original state, and is ready for the next cycle of motion. While plates 208 and 212 maintain the oscillatory motion synchronized with switch 218, current flows through load resistors 210, 216, and 217, resulting in energy collection. Load resistors 210, 216, and 217 with the surrounding equivalent capacitors form RC circuits with time constants related to RC values. To maximize the collected energy, the time constants are large enough so that the energy collection time is large as well but small enough so that the two neighboring processes do not overlap. With system 200, an electric motor can be provided with an external DC source of plates 220 and 222.

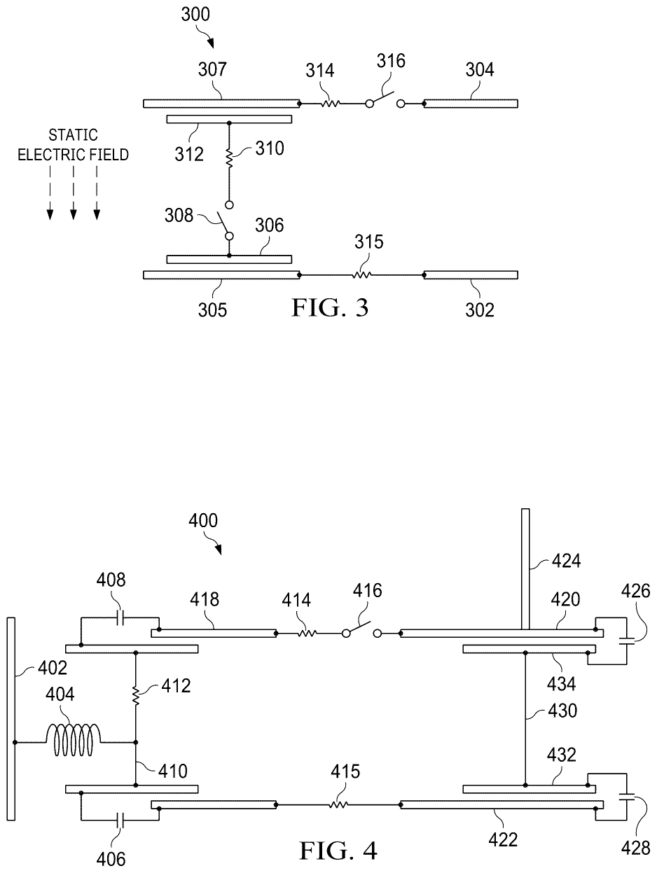

FIG. 3 is a diagram of a system 300 for an electronic version of FIG. 2 DC energy harvesting where no mechanical movement is required, in accordance with an example embodiment of the present disclosure. Switches 308 and 316 eliminate the need for mechanical movement if plates 302 and 304 contain a large quantity of charges. There are two sections in plates 305 and 307. Section 1 covers the region of only plates 305 and 307 whereas section 2 is the overlapping region of plates 305 and 307 and the inner two parallel plates 306 and 312 connected with switch 308 and load resistor 310. A suitable combination of switch 308 and 316 states will produce electric currents. For example, one state is where switches 308 and 316 are off. In a second state, switch 316 is on so that plates 305 and 307 are charged by plates 302 and 304, maintaining a constant voltage between plates 305 and 307. In a third state, switch 316 is off. In a fourth state, switch 308 is on, making the voltage of plates 305 and 307 lower by transferring charges from section 1 to section 2 of plates 302 and 304. Current flows through load resistor 310, resulting in power collection. In the fifth state, switch 308 is off. In the sixth state, switch 316 is on and current flows through load resistors 314 and 315, which provides another power collection center. In the seventh state, switch 316 is off, returning to state 1 to be ready for the next cycle. While going through different states of the two switches, current flows through resistors 310, 305 and 314, resulting in energy collection. In another example embodiment, load resistors are connected between sections 1 and 2 of plates 305 and 307 to collect power.

In another example embodiment, a synchronized diode can be used to replace each switch in systems 200 and 300. A DC voltage can be connected to the diode to adjust the “activation voltage” which divides the circuit conduction or non-conduction. In this way the two devices will operate passively without external involvement.

FIG. 4 is diagram of a system 400 for an electronic version of DC power collector with capacitors, in accordance with an example embodiment of the present disclosure. System 400 includes base 402 coupled to spring 404, structure 410 coupled to spring 404, load resistor 412, plates 418, plates 420 and 422, load resistors 414 and 415, switch 416, plates 432 and 434 with connector 430 disposed between them, and capacitors 406, 408, 426 and 428.

To increase the output currents and/or make the device smaller, capacitors 406, 408, 426 and 428 can be connected as shown. System 400 is similar to system 200, except capacitors 406, 408, 426 and 428 enhance energy collection. The time constants associated with capacitors 406, 408, 426 and 428 are small enough so that the two neighboring processes do not overlap but large enough so that the energy collection times are maximized by reducing inactive time gaps between active processes.

In another example embodiment, conducting rod 424 is attached on the top patch to increase the voltage.

As an example, the dimensions of the inner and outer plates of the receiver are 100 cm×100 cm, and thicknesses of those plates are 120 mills. The separation distances of the inner and outer plates are 100 cm and 98 cm, respectively. The spring constant is chosen to maintain continuous movement of the H-shaped piston. The power source (the structure in the right side of the diagram) is assumed to be large for a relatively constant voltage. The voltage of the power source is 150 V. The capacitances of the capacitors are 1 mF and the resistances of the load resistors are 100 Ohms. Thus, the time constant is in the order of 0.1 sec, and the optimum rate of oscillation is 10. The energy collected per cycle is 11.3 J and the collected power is 113 W. Here we assume the mechanical design works ideally, and does not consume power. It is noted that charges left from one side of the source do not reach the other side, and the output is AC.

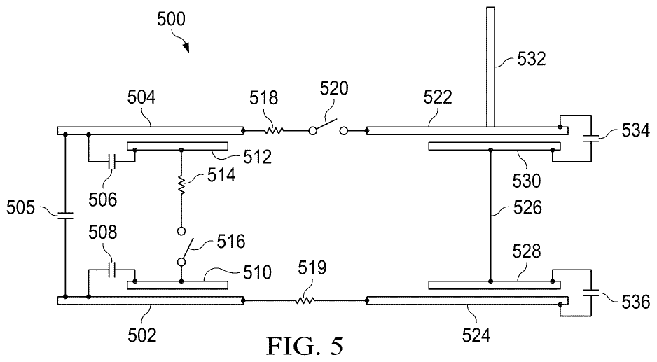

FIG. 5 is diagram of a system 500 for an electronic version of DC power collector with capacitors that does not require mechanical movements, in accordance with an example embodiment of the present disclosure. System 500 includes plates 502 and 504, which are coupled to plates 510 and 512 respectively through capacitors 508 and 506, respectively. Capacitor 505 connects plates 502 and 504. Resistor 519 connects plates 502 and 524. Switch 516 is coupled to resistor 514, resistor 518 is coupled to switch 520, and plates 528 and 520 are coupled to plates 524 and 522, respectively, through capacitors 536 and 534, respectively.

To increase the output currents and/or make the device smaller, capacitors 505, 506, 508, 534 and 536 can be connected as shown. System 500 is similar to system 300, except capacitors 506, 508, 534 and 536 enhance energy collection. The time constants associated with capacitors 506, 508, 534 and 536 are small enough so that the two neighboring processes do not overlap but large enough so that the energy collection times are maximized by reducing inactive time gaps between active processes.

In another example embodiment, conducting rod 532 is attached on the top patch to increase the voltage.

As an example, the dimensions of the inner and outer plates of the receiver are 50 cm (width)×100 cm (length) and 100 cm×100 cm, respectively, the separation distance between the outer plates 100 cm, the gaps between outer and inner plates are 2 cm, and the thicknesses of those plates are 120 mills. The power source (the structure in the right side of the diagram) has a relatively constant voltage of 150 V. The capacitances of the capacitors are 1 mF and the resistances of the load resistors are 100 Ohms. Thus, the time constant is in the order of 0.1 sec, and the optimum rate of oscillation is 10. The collected power is 113 W, the same as that of the example of FIG. 4, the corresponding mechanical version. It is noted that charges left from the source do not reach the other side but return to the source, and the output is AC.

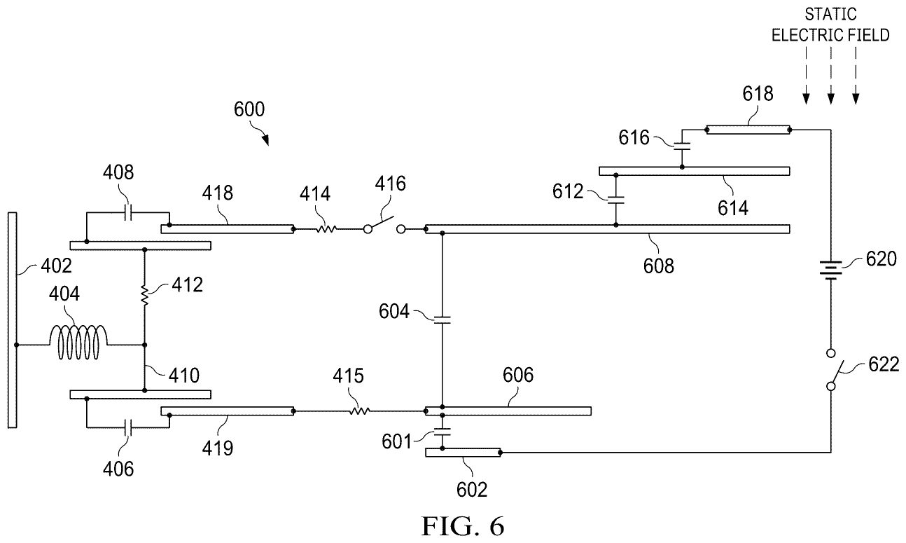

FIG. 6 is diagram of a system 600 for energy collection, in accordance with an example embodiment of the present disclosure. In addition to the components of system 400, system 600 includes a bottom plate assembly that includes plate 606 coupled to conductor 602, capacitor 604 that couples plate 606 to plate 608, capacitor 601 that couples plate 606 and plate 602, capacitor 612 couples plate 608 to plate 614, capacitor 616 couples plate 614 to plate 618 and battery 620 and battery switch 622 couple plate 618 to plate 602. Capacitor 601 couples plate 606 to switch 602. The operation is similar to that of system 400 except that charge split occurs between capacitors 604 and 612, meaning the amount of charge on the top conductor of capacitor 604 is approximately the same as that on the bottom conductor of capacitor of 612, but oppositely charged. In this way the system provides much larger dynamic range of charge distribution than that without capacitors 604 and 614.

Plate 608 consists of two sections: section 1 is the overlapping region of plate 608 with plate 614, and section 2 is the overlapping region of plate 608 and plate 606. Plate 614 maintains a potential higher than plate 608 and plate 608 has a higher potential than plate 606. Capacitor 604 connects section 1 of plate 608 and plate 606. The top portion of capacitor 604 is positively charged, and the bottom portion is negatively charged. Capacitor 612 connects section 2 of plate 608 and plate 614, resulting in positive charges on the top and negative charges at the bottom portion of capacitor 612. In other words, there is charge split between capacitor 604 and capacitor 612, where the amounts of charges on those two capacitors are about the same.

In order to reduce the effect of the migrant charges and limit the migrant charges to counter the effect of the external electric field, plate 618 is added with capacitor 616 above plate 614, and plate 602 is added with capacitor 601 below plate 606. Plates 618 and 602 are connected with battery 620 and switch 622. Plates 618 and 602, and capacitors 616 and 601 are initially charged by battery 620 switch 622 is on and off before the energy collection begins.

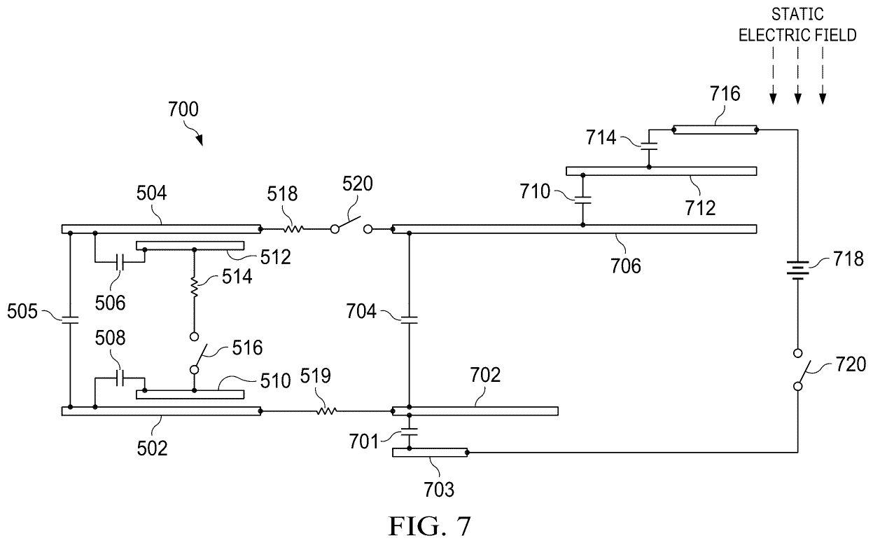

FIG. 7 is diagram of system 700 for an electronic version of FIG. 6 for energy collection where mechanical movements are not required, in accordance with an example embodiment of the present disclosure. In addition to the components of system 500, system 700 includes a bottom plate 702, capacitor 704 that couples plate 702 to plate 706, capacitor 710 that couples plate 706 to plate 712, capacitor 714 that couples plate 712 to plate 716, and battery 718 and battery switch 720 couple plate 716 to plate 703, which is connected to plate 702 with capacitor 701. System 700 is an electronic version of DC power collector with capacitors, a charge splitter, and a battery, where the energy output is further increased by limiting polarizability with use of a battery, as in FIG. 6.

Plate 706 consists of two sections: section 1 is the overlapping region of plate 706 with plate 702, and section 2 is the overlapping region of plate 706 and plate 712 which is connected to plate 716 with capacitor 714. Plate 712 maintains a potential higher than plate 706 and plate 706 has a higher potential than plate 702. Capacitor 701 connects plates 702 and 703, and capacitor 714 connects plates 712 and 716. Section 1 of plate 706 and plate 702 are connected with capacitor 704 where the top portion of the capacitor is positively charged, and the bottom portion is negatively charged. Capacitor 710 connects section 2 of plate 706 and plate 712, resulting in positive charges on the top and negative charges at the bottom portion of capacitor 710. In other words, there is charge split between capacitor 704 and capacitor 710, where the amounts of charges on those two capacitors are about the same since the equivalent capacitances of the capacitors between section 1 of plate 706 and plate 702, and section 2 of plate 706 and plate 712 are very small compared to the capacitances of capacitors 704 and 710. Therefore, it is fair to say that the charges are split in the capacitors.

To limit the effect of the migrant charges to counter the effect of the external electric field, plate 716 is connected to plate 712 with capacitor 714, and plate 703 is connected to plate 702 with capacitor 701. Plates 716 and 703 are connected with battery 718 and switch 720. Plates 716 and 703, and capacitors 714 and 701 are initially activated by battery 718 with switch 720 turned on and then off.

The operations of systems 600 and 700 are similar to those of systems 400 and 500, respectively, except that systems 600 and 700 contain an extra load resistor and have a higher dynamic output range due the charge split scheme with an external charge source.

The following is an example of the power source or charge reservoir in FIGS. 6 and 7. As for FIG. 7, the capacitances are 1 F for capacitors 710 and 704, and 10 F for capacitors 714 and 701. The thicknesses and widths of all the conducting plates are the same at 100 cm and 120 mils, respectively, with the lengths of 50 cm (716), 300 cm (712), 600 cm (706), and 300 cm (702). The separation distances are 10 cm between plates 716 and 712, and 100 cm between plates 712 and 706, 100 cm between plates 706 and 702, and 10 cm between plates 702 and 703. The entire lengths of plates 716 and 703 are overlapped with plates 712 and 702, respectively. Plate 706 is divided in half, where the left section is overlapped with plate 702, and the right section with plate 702 as shown in FIG. 7. The external electric field strength is 150 V/m. The initial voltage of the battery is 330 V, and the charge at each capacitor is 150 C. The capacitors 704 and 710 can be used for the power source or charge reservoir as shown in FIGS. 6 and 7. In the example of FIGS. 4 and 5, the maximum charge fluctuation is about 0.15 C, which is 0.1% of the charges stored on capacitors 704 and 710. Such small variation is smoothed out by the external static electric field.

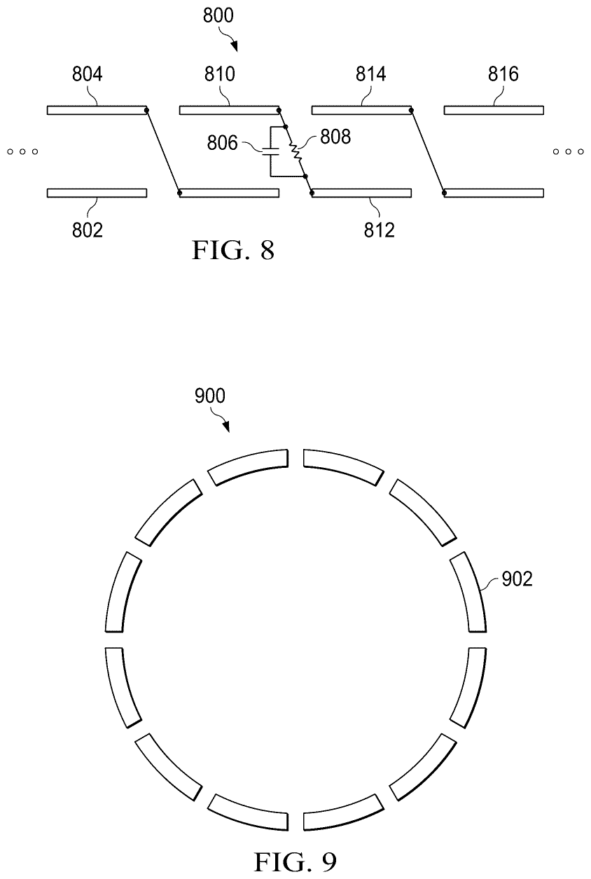

FIG. 8 is system 800 for AC power collection, in accordance with an example embodiment of the present disclosure. System 800 includes plate 802, which is disposed under the top portion of plate 804. Plate 804 includes a bottom portion that is disposed under plate 810. Plate 810 is coupled to plate 812 through capacitor 806 and resistor 808. Plate 814 has a top portion that is disposed over plate 812, and a bottom portion that is disposed under plate 816. System 800 collects AC power at low frequencies where the quasi-static approximation is valid. The amplitude of the low-frequency AC signal is increased by connecting the parallel plates horizontally.

FIG. 9 is diagram of a system 900 for use with the embodiment of system 800. The beginning point is connected to the ending point as shown. A load resistor can be connected in parallel with a capacitor to increase the output power.

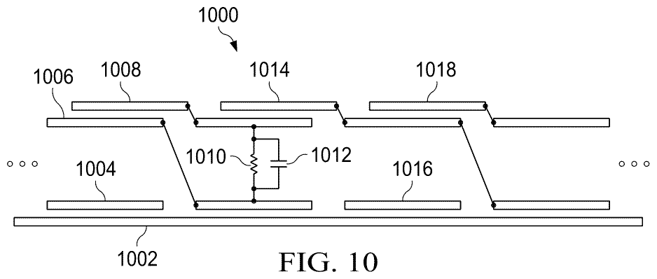

FIG. 10 is a diagram of a system 1000 for collecting AC energy, in accordance with an example embodiment of the present disclosure. System 1000 includes bottom plate 1002, plate 1004 disposed over bottom plate 1002, plate 1006 disposed over plate 1004, plate 1008 disposed over plate 1008 and coupled to plate 1006 via resistor 1010 and capacitor 1012, plate 1014 disposed over plate 1008, plate 1016 disposed under plate 1014 and plate 1018 disposed over plate 1014. At low frequencies, each cell of the parallel plates causes an AC signal to be amplified. Capacitor 1012 is connected in parallel with resistor 1010 to increase the power output.

The dimensions of all disclosed components, such as the radius of rotating cylindrically shaped conducting plates 104 and stationary cylindrically shaped conducting plates 102, the dimensions of all plates and other disclosed physical components will depend on the application. In one example embodiment, the total device size can be approximately 1 meter in length, width and depth. In another example embodiment, the embodiments with plates can be on order of 10 meters. In another example embodiment, the diameter of rotating cylindrically shaped conducting plates 104 is 98 cm and the diameter of stationary cylindrically shaped conducting plates 102 is 1 meter. The plates should have sufficient material strength to also provide structural support, such as 62 mil thickness.

The materials that the disclosed conducting components can be fabricated from include copper, aluminum or other suitable conductors, and can be fabricated according to commercially acceptable processes. The rotating speed ranges of any rotating components can be a function of the time constant determined by the resistance and capacitance. For example, if C=1 mF and R=50 Ohms, the time constant is 0.05 sec, and the rotation rate is about 10 cycles per second.

The present disclosure utilizes displacement current density, which is defined by time variation of electric flux density. The flux density is electric field strength times permittivity. The permittivity of free-space is 8.854×10−12 F/m. Creation of an AC environment from the DC electric field can be accomplished using mechanical movement (rotational or linear), or switches, or combination of those two. Energy must be spent to get more energy than the input, to produce positive net energy. In order to obtain an increase in the output energy that is greater than the energy input into the system, capacitors (and/or batteries) are utilized to increase the output to an appreciable level. With these two components, the field distribution around the devices significantly changes with time to result in appreciable currents through load resistors that lead to power collection.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. A system can receive one or more data inputs, such as data fields, user-entered data, control data in response to a user prompt or other suitable data, and can determine an action to take based on an algorithm, such as to proceed to a next algorithmic step if data is received, to repeat a prompt if data is not received, to perform a mathematical operation on two data fields, to sort or display data fields or to perform other suitable well-known algorithmic functions. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for collecting energy, comprising:
a stationary component disposed in an electric field, the stationary component is load resistors and/or capacitors;
a dynamic component disposed adjacent to the stationary component in the electric field, the dynamic component including mechanical movements and/or switches; and
a device for creating a time-varying physical interaction between the stationary component and the dynamic component to generate a current flow in the load resistors.

2. The system of claim 1 wherein the device for creating the time-varying physical interaction comprises a rotational device coupled to the dynamic component.

3. The system of claim 1 wherein the device is a power generator for creating the time-varying physical interaction comprises a rotational device coupled to the dynamic component and the electric field strength being zero.

4. The system of claim 1 wherein the stationary component has a cylindrical form, the dynamic component has a cylindrical form and the device for creating the time-varying physical interaction comprises a rotational device coupled to the dynamic component.

5. The system of claim 1 wherein the stationary component is a conducting plate and the dynamic component is a conducting plate.

6. The system of claim 1 wherein the stationary component is a conducting plate, the dynamic component is a conducting plate and the device for creating a time-varying physical interaction between the stationary component and the dynamic component causes the dynamic component to oscillate relative to the stationary component.

7. The system of claim 1 wherein the stationary component is a conducting plate, the dynamic component is a conducting plate and the device for creating a time-varying physical interaction between the stationary component and the dynamic component causes a switch to change a capacitive coupling between the dynamic component and the stationary component.

8. The system of claim 1 wherein the device for creating a time-varying physical interaction between the stationary component and the dynamic component comprises an electric motor.

9. The system of claim 1 wherein the stationary component comprises two parallel plates.

10. The system of claim 1 wherein the dynamic component comprises an H-shaped conductor disposed between two parallel plates of the stationary component.

11. The system of claim 1 wherein the device for creating a time-varying physical interaction between the stationary component and the dynamic component comprises one or more switches.

12. The system of claim 1 wherein the device for creating a time-varying physical interaction between the stationary component and the dynamic component comprises a diode with an adjustable activation voltage.

13. The system of claim 1 further comprising one or more capacitors coupled between the stationary component and the dynamic component.

14. The system of claim 1 further comprising a charge splitter coupled to one of the stationary component or the dynamic component.

15. The system of claim 1 further comprising a battery coupled to the stationary component and configured to modify a voltage of the stationary component.

16. The system of claim 1 further comprising a conducting rod coupled to the stationary component.
